(19) United States
(12) Patent Application Publication
(10) Pub. No.: US 2011/0049402 A1
(43) Pub. Date: Mar. 3, 2011

(54) Adaptive Controller of Auma MOV's Actuator

(75) Inventor: Yu-Chang HSU, Taoyuan city (TW)

(73) Assignee: ATOMIC ENERGY COUNCIL-INSTITUTE OF NUCLEAR ENERGY RESEARCH, Taoyuan (TW)

(21) Appl. No.: 12/547,679

(22) Filed: Aug. 26, 2009

(51) Int. Cl. F16K 31/02

(52) U.S. Cl. 251/129.01

(57) ABSTRACT

An adaptive controller is provided. The controller is used to control and test an actuator of auma motor operated valve (MOV). The controller has a panel for easily testing and operating the actuator coordinated with diagnostic equipments and jigs.

### FIELD OF THE INVENTION

The present invention relates to an adaptive controller; more particularly, relates to using a valve open/close unit, a torque switch unit and a diagnostic control unit on a panel to test and operate an actuator of auma motor operated valve (MOV) with jigs easily.

### DESCRIPTION OF THE RELATED ARTS

Electric actuators used in a nuclear power plant have to pass through thrust diagnostic test periodically, where current clamps or alligator clips are used to measure current signals from motor and those obtained on opening equipments.

Electric actuators used in nuclear power plant are usually Limitorque electric actuators 7 (in FIG. 4) or Rotork electric actuators 8 (in FIG. 5). Hence, test equipments for the electric actuators are mainly designed for the Limitorque electric actuators 7 or the Rotork electric actuators 8. Current clamps or alligator clips are directly clipped to limit switches 71, 81 of the Limitorque electric actuators 7 or the Rotork electric actuators 8, like hub terminal boards or limit/torque switches. General current clamps or alligator clips are thus not fit for controlling and testing auma MOV's actuators. Hence, the prior arts do not fulfill all users' requests on actual use.

### SUMMARY OF THE INVENTION

The main purpose of the present invention is to use a valve open/close unit, a torque switch unit and a diagnostic control unit on a panel to test and operate an auma MOV's actuator with jigs easily.

To achieve the above purpose, the present invention is an adaptive controller of auma MOV's actuator, comprising an auma MOV's actuator, a valve open/close unit, a torque switch unit, a diagnostic control unit and a breaker, where the auma MOV's actuator has a panel; the valve open/close unit, the torque switch unit, the diagnostic control unit and the breaker are electrically connect with the auma MOV's actuator and are set on the panel; the diagnostic control unit has a first terminal panel and a second terminal panel abidingly set; the first terminal panel and the second terminal panel have a plurality of corresponding ports separately; and the ports at least at a side are connected with cables. Accordingly, a novel adaptive controller of auma MOV's actuator is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the view showing the panel;

FIG. 3 is the view showing the diagnostic equipment;

FIG. 4 is the view of the Limitorque electric actuator; and

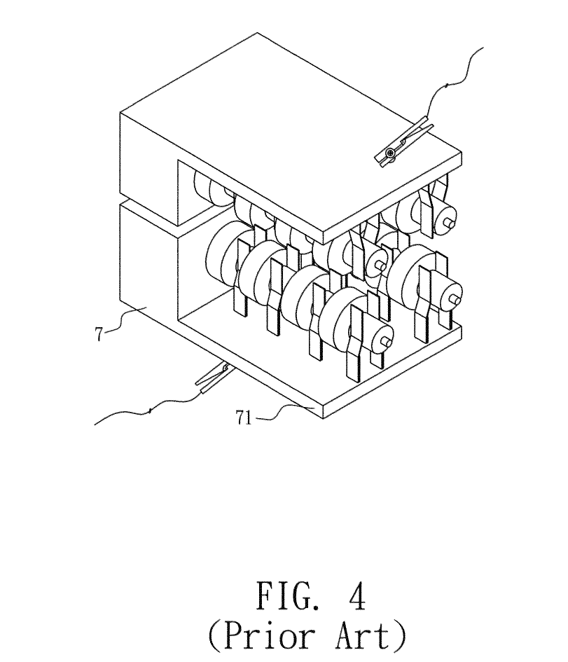

FIG. 5 is the view of the Rotork electric actuator.

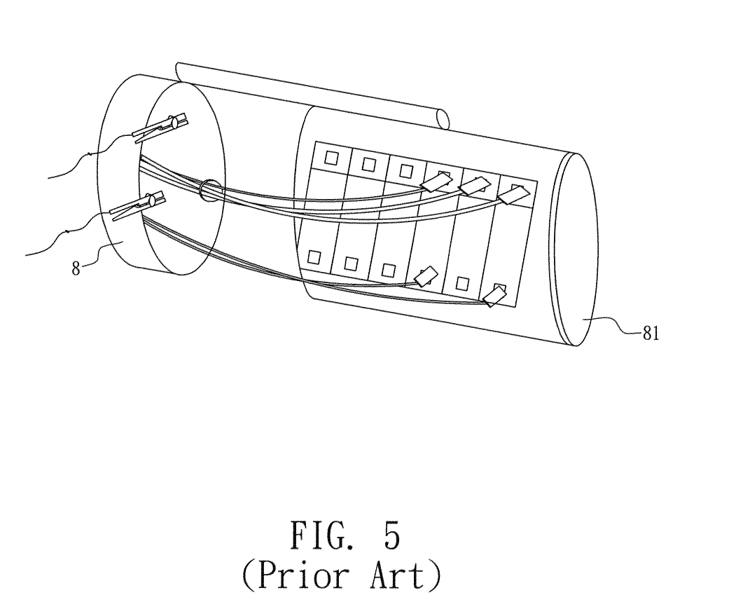

### DESCRIPTION OF THE PREFERRED EMBODIMENT

The following description of the preferred embodiment is provided to understand the features and the structures of the present invention.

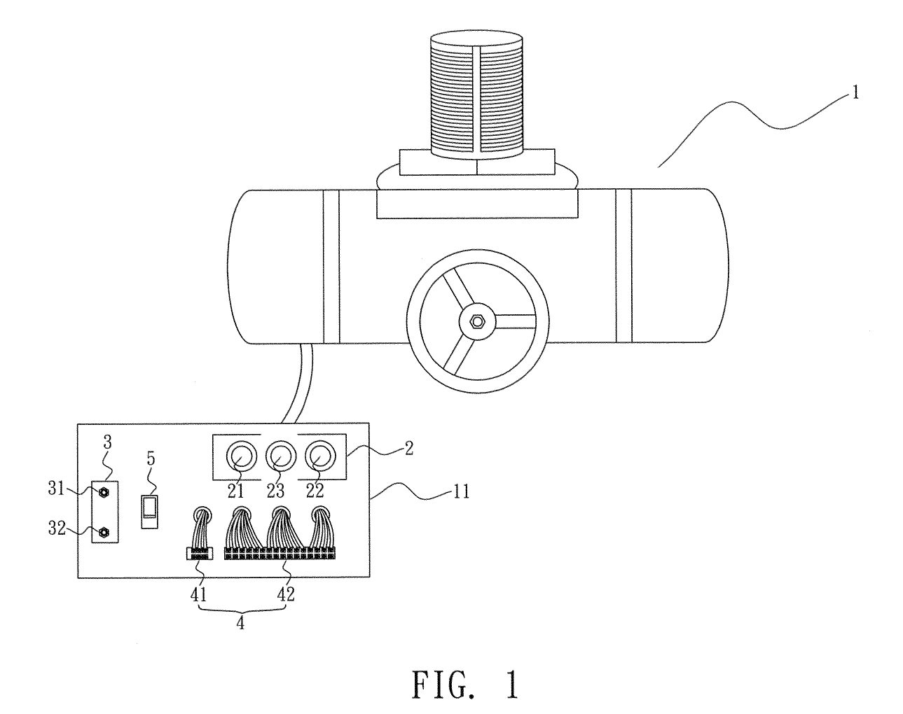

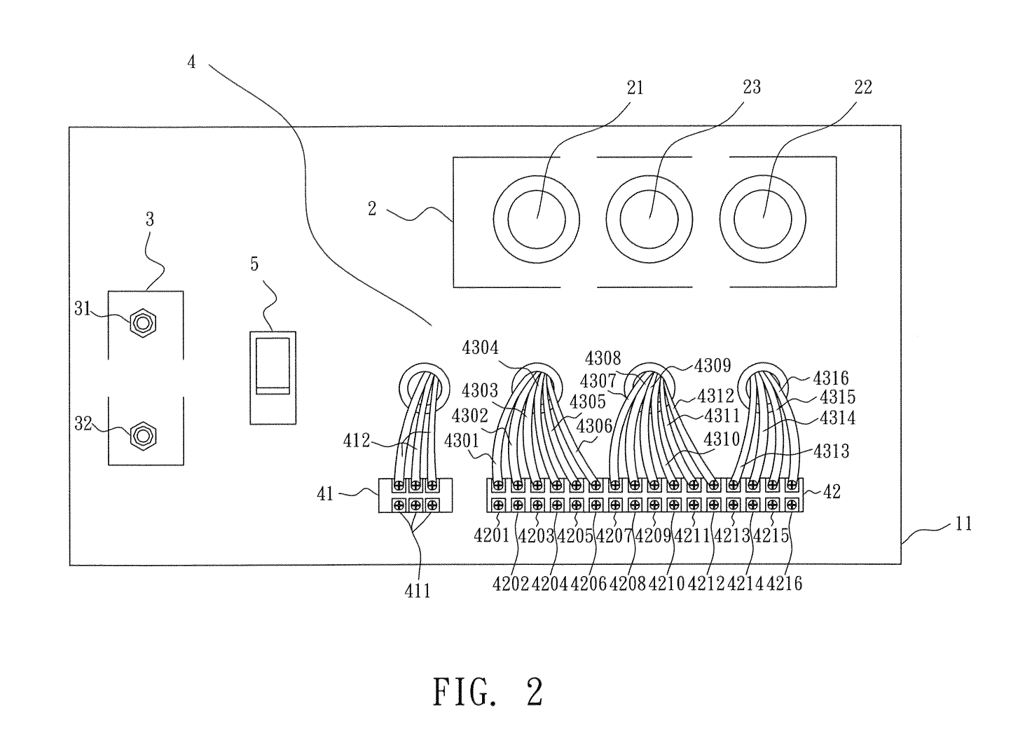

Please refer to FIG. 1 and FIG. 2, which are a perspective view showing a preferred embodiment according to the present invention; and a view showing a panel. As shown in the figures, the present invention is an adaptive controller of auma auma motor operated valve's (MOV's) actuator, comprising an auma MOV's actuator 1, a valve open/close unit 2, a torque switch unit 3, a diagnostic control unit 4 and a breaker 5.

The auma MOV's actuator 1 has a panel 11.

The valve open/close unit 2 is electrically connected with the auma MOV's actuator 1 and is set on the panel 11. The valve open/close unit 2 comprises a light opening unit 21, a light closing unit 22 and an indicating part 23, where the light opening unit 21 and the light closing unit 22 are of twist type, press type or turn type.

The torque switch unit 3 is electrically connected with the auma MOV's actuator 1 and is set on the panel 11. The torque switch unit 3 comprises a torque opening switch 31 and a torque closing switch 32, where the torque opening switch 31 and the torque closing switch 32 are of twist type, press type or turn type.

The diagnostic control unit 4 is electrically connected with the auma MOV's actuator 1 and is set on the panel 11. The diagnostic control unit 4 has a first terminal panel 41 and a second terminal panel 42 abidingly set. Therein, the first terminal panel 41 has a plurality of corresponding ports 411; the first terminal panel 411 has ports 411 at a side connected with cables 412 separately; and the second terminal panel 42 has a first to a sixteenth ports 4201˜4216 connected with cables 4301˜4316 separately.

The breaker 5 is electrically connected with the auma MOV's actuator 1 and is set on the panel 11.

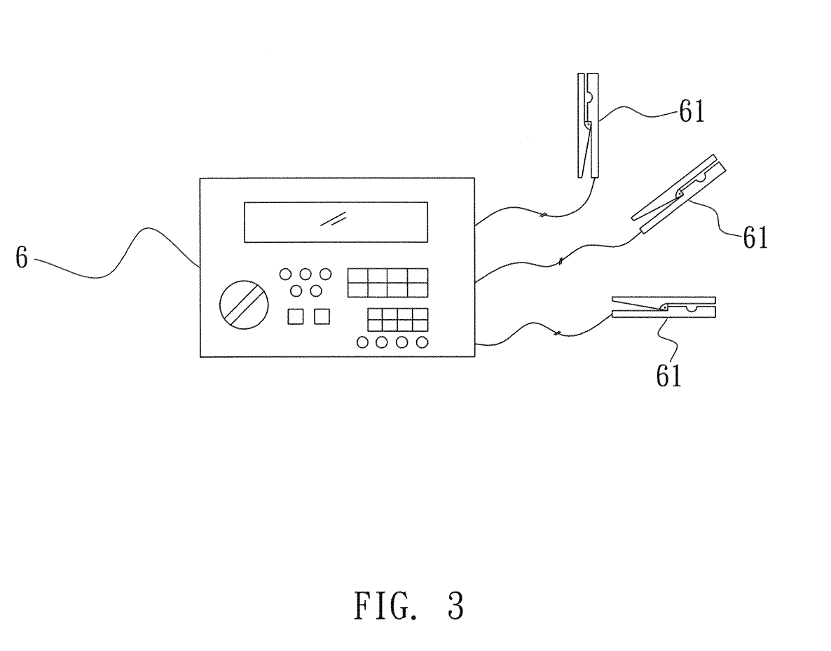

Please further refer to FIG. 3, which is a view showing a diagnostic equipment. As shown in the figure, on using the present invention, the light opening unit 21 of the valve open/close unit 2 is used to switch on the auma MOV's actuator 1 and the indicating part 23 is lighted to show a ‘switch-on’ state. Then the torque opening switch 31 of the torque switch unit 3 is switched on to operate the auma MOV's actuator 1. For stopping the auma MOV's actuator, the torque closing switch 32 of the torque switch unit 3 is used to eliminate torque of the auma MOV's actuator 1 at first. Then, the light closing unit 22 of the valve open/close unit 2 is used to switch off the auma MOV's actuator 1 and the indicating part 23 is lighted to show a ‘switch-off’ state. Thus, the valve open/close unit 2 and the torque switch unit 3 on the panel 11 are used to switch on and switch off the auma MOV's actuator. When the auma MOV's actuator 1 is overloaded with a transient current on operating, a breaker 5 is used to break the auma MOV's actuator 1 for preventing damages to the auma MOV's actuator 1.

After the auma MOV's actuator 1 is operated for a while, the diagnostic control unit 4 on the panel 1 is used to diagnose the auma MOV's actuator 1. On diagnosing the auma MOV's actuator 1, jigs 61 of the diagnostic equipment 6, like current clamps or alligator clips, are clipped to related cables 412, 4301˜4316 of the first and the second terminal panels 41, 42. Related diagnostic methods and items include the followings:

1. Jigs 61 are clipped to cables 412 of the ports 411 of the first terminal panel 41 for a test of three phase alternative current (AC) power to the auma MOV's actuator 1.

2. Jigs 61 are clipped to cables 4301, 4302 of the first and the second ports 4201, 4202 of the second terminal panel 42 for a test of torque at closing stroke to the auma MOV's actuator 1.

3. Jigs 61 are clipped to cables 4303, 4304 of the third and the fourth ports 4203, 4204 of the second terminal panel 42 for a test of torque at opening stroke to the auma MOV's actuator 1.

4. Jigs 61 are clipped to cables 4305, 4306 of the fifth and the sixth ports 4205, 4206 of the second terminal panel 42 for a test of limit at closing stroke to the auma MOV's actuator 1.

5. Jigs 61 are clipped to cables 4307, 4308 of the seventh and the eighth ports 4207, 4208 of the second terminal panel 42 for a test of limit at opening stroke to the auma MOV's actuator 1.

6. Jigs 61 are clipped to cables 4309, 4310 of the ninth and the tenth ports 4209, 4210 of the second terminal panel 42 for a test of partial stroke at closing stroke to the auma MOV's actuator 1.

7. Jigs 61 are clipped to cables 4311, 4312 of the eleventh and the twelfth ports 4211, 4212 of the second terminal panel 42 for a test of partial stroke at opening stroke to the auma MOV's actuator 1.

8. The thirteenth to the sixteenth ports 4213˜4216 of the second terminal panel 42 are coordinated with cables 4313˜4316 to be used as control cables to the auma MOV's actuator 1.

To sum up, the present invention is an adaptive controller of auma MOV's actuator, where a valve open/close unit, a torque switch unit and a diagnostic control unit on a panel are used for tests and related operations; and the diagnostic control unit is coordinated with jigs for testing and operating the auma MOV's actuator easily.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An adaptive controller of auma motor operated valve's (MOV's) actuator, comprising
an auma MOV's actuator, said auma MOV's actuator having a panel;
a valve open/close unit, said valve open/close unit being electrically connected with said auma MOV's actuator, said valve open/close unit being set on said panel;
a torque switch unit, said torque switch unit being electrically connected with said auma MOV's actuator, said torque switch unit being set on said panel;
a diagnostic control unit, said diagnostic control unit being electrically connected with said auma MOV's actuator, said diagnostic control unit being set on said panel, said diagnostic control unit having a first terminal panel and a second terminal panel abidingly set, said first terminal panel and said second terminal panel having a plurality of corresponding ports separately, said ports at least at a side being connected with cables; and
a breaker, said breaker being electrically connected with said auma MOV's actuator, said breaker being set on said panel.

2. The adaptive controller according to claim 1,
wherein said valve open/close unit comprises a light opening unit, a light closing unit and an indicating part.

3. The adaptive controller according to claim 2,
wherein said light opening unit and said light closing unit are of a type selected from a group consisting of twist type, press type and turn type.

4. The adaptive controller according to claim 1,
wherein said torque switch unit comprises a torque opening switch and a torque closing switch.

5. The adaptive controller according to claim 4,
wherein said torque opening switch and said torque closing switch are of a type selected from a group consisting of twist type, press type and turn type.

6. The adaptive controller according to claim 1,
wherein said ports on said first terminal panel are processed through tests of three phase alternative current (AC) power with cables coordinated.

7. The adaptive controller according to claim 1,
wherein said second terminal panel has a first to a sixteenth ports connected with cables separately.

8. The adaptive controller according to claim 7,
wherein said first and said second ports are coordinated with cables to test torque at closing stroke.

9. The adaptive controller according to claim 7,
wherein said third and said fourth ports are coordinated with cables to test torque at opening stroke.

10. The adaptive controller according to claim 7,
wherein said fifth and said sixth ports are coordinated with cables to test limit at closing stroke.

11. The adaptive controller according to claim 7,
wherein said seventh and said eighth ports are coordinated with cables to test limit at opening stroke.

12. The adaptive controller according to claim 7,
wherein said ninth and said tenth ports are coordinated with cables to test partial stroke at closing stroke.

13. The adaptive controller according to claim 7,
wherein said eleventh and said twelfth ports are coordinated with cables to test partial stroke at opening stroke.

14. The adaptive controller according to claim 7,
wherein said thirteenth to said sixteenth ports are coordinated with cables to be used as control cables.
